(19) United States
(12) Patent Application Publication
(10) Pub. No.: US 2014/0343836 A1
(43) Pub. Date: Nov. 20, 2014

(54) METHOD FOR OPERATING A FIRST-PARTY VEHICLE

(71) Applicant: Dr. Ing. h.c.F. Porsche Aktiengesellschaft, Stuttgart (DE)

(72) Inventor: Timo Maise, Neckarweihingen (DE)

(73) Assignee: Dr. Ing. h.c.F. Porsche Aktiengesellschaft, Stuttgart (DE)

(21) Appl. No.: 14/275,951

(22) Filed: May 13, 2014

(30) Foreign Application Priority Data
May 17, 2013 (DE) 102013105103.0

(51) Int. Cl. G08G 1/16

(52) U.S. Cl. CPC G08G 1/166
USPC 701/301

(57) ABSTRACT

A method for operating a first-party vehicle that is traveling in a current lane along a road that is divided into a plurality of lanes includes announcing an intended change for the first-party vehicle from the current lane to a further, adjacent lane by activation of a direction-of-travel indicator. A trajectory is calculated for the first-party vehicle that is conditional upon the intended change to the further lane in response to the announcement of the intended change to the further lane. Information is evaluated about at least one kinematic variable for a third-party vehicle so as to calculate an envisaged trajectory for the at least one third-party vehicle. A check is performed so as to determine whether the trajectory of the first-party vehicle that is conditional upon the intended change coincides with the envisaged trajectory of the at least one third-party vehicle at a future instant.

### CROSS REFERENCE TO RELATED APPLICATIONS

This application claims priority from German Patent Application No. DE 10 2013 105 103.0, filed May 17, 2013, which is hereby incorporated by reference herein in its entirety.

### FIELD

The invention relates to a method and a system for operating a first-party vehicle.

### BACKGROUND

A driver of a vehicle can be assisted by using what is known as an assistance system that can be used to register operational and/or environmental parameters from a vehicle. By taking account of such operational and/or environmental parameters, it is possible to warn the driver about any hazards before a possible maneuver with the vehicle is made.

The document DE 101 33 283 A1 discloses a warning system for collision avoidance in road traffic. The warning system is used to register and evaluate signals from an intervehicle communication system by means of a warning apparatus. When a vehicle approaches such a warning apparatus in critical fashion, a signal is triggered that warns a road user that is endangered thereby. The signal can also be transmitted to the driver of the critically approaching vehicle. In addition, telematic devices can be used to take direction action in the control of the vehicle in situations where time is critical.

A vehicle communication system is described in document DE 199 48 733 A1, said vehicle communication system being designed for communication between vehicles and having a transmitter arranged on a first vehicle for sending information, a receiver arranged on another vehicle for receiving the information and a display device for displaying the information. The vehicle communication system is used to limit exchange of information to vehicles within a transmitter range for which this information is relevant. In this case, the vehicle communication system also comprises a device for registering a motion state of another vehicle. In addition the vehicle communication system is designed such that, regardless of a collision course, signals are displayed in the display device of a vehicle provided with a receiver only if the vehicle is in a predetermined motion state relative to the vehicle equipped with a transmitter.

A traffic system for avoiding accidents is described in the document U.S. Pat. No. 6,472,978 B1. This traffic system can be used to alert a vehicle, the driver thereof, but also pedestrians, by radio communication if the vehicle is at too short a distance from another vehicle or the pedestrian. This involves the traffic system being used to monitor a traffic volume. Furthermore, the pedestrian can use a communication appliance to exchange information about the traffic with a communication appliance of a vehicle.

### SUMMARY

In an embodiment, the present invention provides a method for operating a first-party vehicle that is traveling in a current lane along a road that is divided into a plurality of lanes. The method includes announcing an intended change for the first-party vehicle from the current lane to a further, adjacent lane on the road by activation of a direction-of-travel indicator on the first-party vehicle. A trajectory is calculated, in response to the announcement of the intended change to the further lane, for the first-party vehicle that is conditional upon the intended change to the further lane. Information is evaluated about at least one kinematic variable for at least one third-party vehicle that is situated on the road so as to calculate an envisaged trajectory for the at least one third-party vehicle. A check is performed so as to determine whether the trajectory of the first-party vehicle that is conditional upon the intended change coincides with the envisaged trajectory of the at least one third-party vehicle at a future instant.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 uses a schematic illustration to show a first traffic situation in the case of a first embodiment of the method according to the invention.

FIG. 2 uses a schematic illustration to show a second traffic situation in the case of a second embodiment of the method according to the invention.

### DETAILED DESCRIPTION

A method according to an embodiment of the invention is designed for operating a first-party vehicle, usually for implementing a function for this first-party vehicle. In this case, the first-party vehicle is traveling in a current lane along a road that is divided into a plurality of, i.e. at least two, lanes. An intended and/or planned change for the first-party vehicle from the current lane to a further, adjacent lane on the road is announced by activation of a direction-of-travel indicator on the first-party vehicle. Announcement of the intended change to the further lane prompts the calculation of a trajectory for the first-party vehicle that is conditional upon the intended change to the further lane. Evaluation of information about at least one kinematic variable or motion variable, i.e. location, speed, and/or acceleration, for at least one third-party vehicle that is situated on the road calculates an envisaged trajectory for this at least one third-party vehicle. Furthermore, a check is performed to determine whether the trajectory of the first-party vehicle that is conditional upon the intended change coincides with the envisaged and/or calculated trajectory of the at least one third-party vehicle at a shared, future instant, as a result of which it is possible to forecast a threatened collision between the first-party vehicle and the third-party vehicle.

Within the context of the disclosure, a trajectory is understood to mean a curved path along which the respective vehicle is about to move under currently, i.e. the instant of a respective calculation, existing conditions. When the respective trajectories are calculated according to the invention, the respective temporal progression or dependency of said trajectories also needs to be determined.

According to one embodiment according to the invention, the direction-of-travel indicator that can be activated in this case is in the form of a turn signal. Usually, the outside of a vehicle always has at least one direction-of-travel indicator arranged on it that can be activated by a driver of the vehicle using a functional element, for example, a switch.

According to a further embodiment of the method according to the invention, information about the at least one kinematic variable of the at least one third-party vehicle that is situated on the road is provided by at least one third-party vehicle that is situated on the road via a radio-based, wireless communication network. According to one possible embodiment of the method according to the invention, such information is provided by the at least one third-party vehicle via the communication network directly. It is also possible for such information about a third-party vehicle to be provided by at least one further third-party vehicle via the communication network. In this case, the communication network comprises a plurality of communication modules, wherein such a communication module may be arranged in and/or on a vehicle, i.e. a first-party vehicle or a third-party vehicle. It is also possible for a communication module to be installed at a fixed location in the region of the road, for example at the edge of and/or next to the road.

The radio-based and wireless communication network as a public network may be in the form of WLAN, C2C (car-to-car, for vehicle-to-vehicle communication). In this case, at least one third-party vehicle can use the radio-based, wireless communication network to provide information about the at least one kinematic variable of the at least one third-party vehicle.

According to a further embodiment of the method according to the invention, information about the at least one kinematic variable of the at least one third-party vehicle is ascertained by a surroundings recognition system of the first-party vehicle, wherein the surroundings recognition system has at least one sensor which is designed for surroundings field recognition using electromagnetic waves, for example a radar sensor, lidar sensor, laser sensor, video sensor (camera) and/or an ultrasound sensor.

According to one possible embodiment of the method according to the invention, the intended change of the first-party vehicle to the further lane is provided with a warning if the envisaged trajectory of the first-party vehicle coincides with the envisaged trajectory of the at least one third-party vehicle at the shared future instant of the intended change to the further lane.

In a further embodiment, if the trajectories coincides at the shared future instant then the intended change is prevented by action in the steering system of the first-party vehicle, so that the coincidence of the trajectories is prevented.

The method can be performed for an intended change for the first-party vehicle from the current lane to a further, adjacent lane on the road on which the traffic is flowing in the same direction or in opposite directions by definition or according to traffic law (Road Traffic Act).

In a further embodiment of the method according to the invention, an envisaged trajectory is ascertained by at least one third-party vehicle that is oncoming, ahead and/or behind on the road.

According to another embodiment of the method according to the invention, it is also possible for an envisaged trajectory to be ascertained by at least one third-party vehicle traveling in the current lane and/or in a further, adjacent lane.

The system according to the invention that is also provided is designed for operating a first-party vehicle that is traveling in a current lane along a road that is divided into a plurality of lanes. In this case, the system is arranged in the first-party vehicle and has at least one direction-of-travel indicator, at least one computation unit and at least one information device auf.

Activation of the direction-of-travel indicator using a functional element, which may likewise be in the form of a component of the system, allows an intended change for the first-party vehicle from the current lane to a further, adjacent lane on the road to be announced.

The computation unit is designed so that, when the intended change to the further lane is announced, it calculates a trajectory for the first-party vehicle that is conditional upon the intended change to the further lane.

The at least one information device is designed to provide the computation unit with information about at least one kinematic variable for at least one third-party vehicle that is situated on the road.

In addition, the computation unit is designed to calculate an envisaged trajectory for this at least one third-party vehicle by evaluating the information provided. The computation unit can also be used to check whether the trajectory of the first-party vehicle that is conditional upon or results from the intended change coincides with the envisaged and/or calculated trajectory of the at least one third-party vehicle at a usually shared future instant.

According to one possible embodiment of the system according to the invention, the at least one information device is in the form of a communication module in a radio-based wireless communication network that is designed to provide the computation unit with information about the at least one kinematic variable of the at least one third-party vehicle that is situated on the road a further computation unit of the first-party vehicle. In this case, each vehicle that is situated on the road may contain such a communication module.

Alternatively or in addition, the at least one information device may be in the form of a surroundings-recognition system for the first-party vehicle that is designed to recognize and/or to register information about the at least one kinematic variable of the at least one third-party vehicle and to provide said information for the computation unit.

Independently of a specific embodiment of the at least one information device, the latter can be used to monitor a traffic volume by providing at least one value for at least one current kinematic variable for the third-party vehicle.

According to one embodiment of the method according to the invention, at the moment at which a driver of the first-party vehicle uses the turn signal as a direction-of-travel indicator to announce or make known a lane change, a check is performed to determine whether the lane to which the first-party vehicle is intended to change is free. To this end, possible points of intersection between the trajectory of the first-party vehicle and the trajectory of the at least one third-party vehicle, usually trajectories of all third-party vehicles that are situated on the road in the relatively close surroundings of the first-party vehicle, can be calculated from all messages on the communication network that are received within a definable period of time, which may comprise a few seconds, and hence within the last few seconds.

The definable period of time in this case is usually dependent on a value for at least one kinematic variable, i.e. the location, the speed and/or the acceleration, for the first-party vehicle and/or for the at least one third-party vehicle. Messages on the communication network, which may be in the form of what are known as CAM (Cooperative Awareness Message) messages, comprise inter alia, at least one current value for the at least one kinematic variable for a vehicle, i.e. for the first-party vehicle or the third-party vehicle. Such a message is used to make a current value for the at least one kinematic variable for at least one other vehicle, i.e. a third-party vehicle, available via the communication network.

This measure means that different traffic situations can be taken into account, for example, traffic situations in which third-party vehicles are coming towards the first-party vehicle in the event of an envisaged change to the lane of the oncoming traffic, e.g. on a federal highway or a rural road. In traffic situations that can arise on the freeway, for example, faster vehicles approaching the first-party vehicle coming from behind, can be taken into account. Usually, the method also takes account of slower third-party vehicles ahead. In all cases, the driver of the first-party vehicle is immediately warned by means of a warning apparatus on the system, usually before he actually initiates the lane change, if the trajectory of the first-party vehicle coincides—or, on the basis of the calculation, will coincide—with a trajectory for the at least one third-party vehicle at the shared future instant.

The method according to the invention and/or the system according to the invention can now also be used to register oncoming third-party vehicles in the event of a planned lane change to the lane of the oncoming traffic. The same also applies to slower third-party vehicles ahead, which can likewise be registered.

In one embodiment, it is also possible to dispense with radar sensors if need be, since WLAN, for example, is used as a radio-based and wireless communication network instead. However, it is still possible to use information from a surroundings recognition system of the first-party vehicle, since possibly not all third-party vehicles are designed to use the radio-based and wireless communication network for communication. The radio-based and wireless communication network that is in the form of a WLAN for example, can also be used for warning of local hazards in the road traffic. Usually, the radio-based and wireless communication network can be used to provide and/or register more precise information about kinematic variables for third-party vehicles than the surroundings recognition system, since each third-party vehicle is able to forward current values, usually measured by sensing; for its kinematic variables. Information that can be provided via the surroundings recognition system is usually based on observations on the third-party vehicles, from which the kinematic variables of said third-party vehicles can be calculated and/or derived.

In one embodiment, the method according to the invention can be used to provide a warning of a lane change if a lane to which there is the intention to change is not free. In order to ascertain whether the lane is being used by other road users or third-party vehicles, WLAN technology can be used as an embodiment of a radio-based and wireless communication network that is designed for wireless communication between vehicles via communication modules.

The international Standard ITS G5, which can likewise be used for the method, describes communication via WLAN, which allows manufacturer-independent communication between vehicles to be ensured. Vehicles that are equipped with WLAN can use this technology to warn of local hazards, for example, of queue ends, emergency vehicles and roadworks. Vehicles ahead or possibly fixed units that comprise communication modules, are envisaged as transmitters for hazard information in this case. A vehicle behind can receive a piece of hazard information and warn its driver by means of visual, audible or haptic signals. The ITS G5 standard defines, inter alia, the message CAM (Cooperative Awareness Message), which can be sent by all vehicles at least once per second. This message (CAM) usually comprises a current value for the position (GPS position), a current direction of travel and a current value for the speed as kinematic variables for the vehicle.

In the case of one implementation of the method, the first-party vehicle is warned not only of third-party vehicles by which the first-party vehicle is currently being overtaken when the first-party vehicle wishes to swing out in order to overtake, but also of oncoming third-party vehicles.

The method according to the invention and the system according to the invention can be used to provide an assistance function for a lane change assistant, an overtaking alerter, and/or a speed controller as a possible function. In this case, by way of example, the lane change assistant needs to be activated at the moment at which the driver of the first-party vehicle operates the turn signal. A check is subsequently performed to determine whether the lane to which a change is intended is free. Furthermore, immediate feedback, usually a warning, can subsequently be provided for the driver if the lane is occupied. Alternatively or in addition, feedback that is provided can also be used to explicitly indicate that the intended lane change can be performed. In order to register possible third-party vehicles situated in the lane to which the change is intended, an existent surroundings recognition system, which comprises at least one camera, for example, and/or also the wireless communication network used by various vehicles can be used.

The radio-based wireless communication network that can be used in one embodiment and that is in the form of an information device for providing a current value for the at least one kinematic variable may comprise, as subscribers, not only communication modules in vehicles but also permanently installed monitoring devices having associated communication modules for monitoring vehicles and hence the traffic on the road. Such monitoring devices allow communication modules likewise to be used to monitor and/or ascertain values for kinematic variables for vehicles on the road and to provide them for the first-party vehicle via the communication network.

The method according to the invention can be used to register and monitor the traffic in that lane to which the first-party vehicle is intended to be changed. A function that can be performed using the method can be activated using the direction-of-travel indicator (turn signal), usually using a functional element (switch) for operating the direction-of-travel indicator.

The system according to the invention is designed to perform all the steps of the presented method. In this case, individual steps of this method can also be performed by individual components of the system. In addition, the functions of the system or functions of individual components of the system can be implemented as steps of the method. Furthermore, it is possible for steps of the method to be realized as functions of at least one component of the system or of the entire system.

Further advantages and embodiments of the invention can be found in the description and in the accompanying drawings.

It goes without saying that the features cited above and those yet to be explained below can be used not only in the respectively indicated combination but also in other combinations or on their own without departing from the scope of the present invention.

The invention is illustrated schematically in the drawings by means of embodiments and is described in detail below with reference to the drawings.

The figures are described correlatively and comprehensively, and the same reference symbols denote the same components.

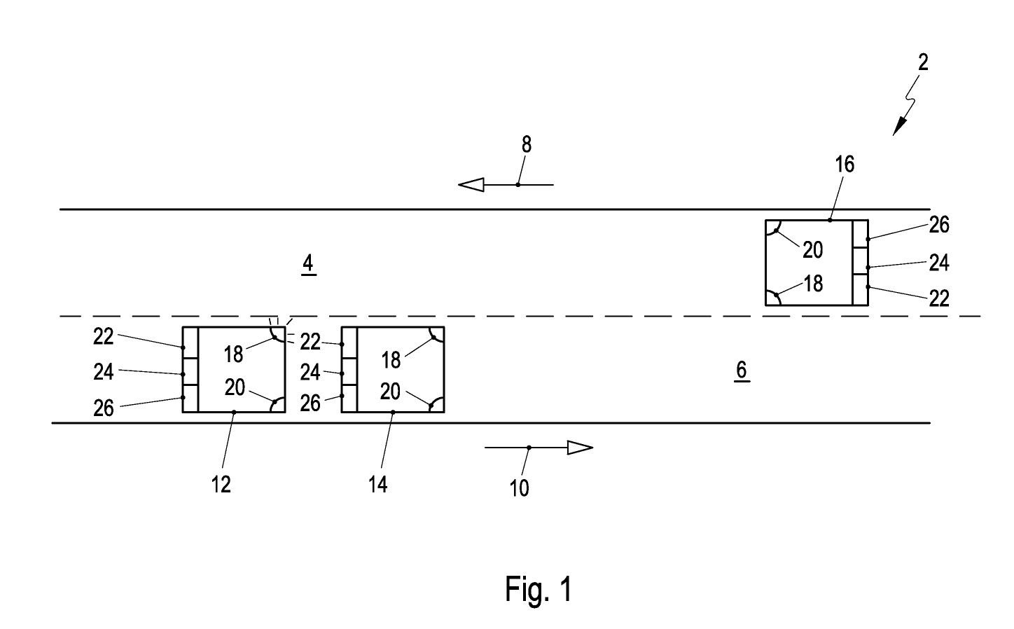

FIG. 1 uses a schematic illustration to show a road 2 having a first lane 4 and a second lane 6, wherein a first direction of travel 8 is provided for the first lane 4 and a second direction of travel 10 is provided for the second lane 6, these two directions of travel 8, 10 being opposite to one another.

In the traffic situation presented by means of FIG. 1, three vehicles are traveling on the road 2, and in this case, without limiting generality, provision is made for a first vehicle to be in the form of a first-party vehicle 12. A second and a third vehicle are in the form of third-party vehicles 14, 16 in this case. The first-party vehicle 12 is traveling along the second lane 6 behind the first third-party vehicle 14 in the second direction of travel 10. At the same time, the second third-party vehicle 16 is approaching the first third-party vehicle 14 and the first-party vehicle 12 in the opposite, first lane 4.

Independently of the traffic situation specifically presented here, each of the vehicles presented here has a first direction-of-travel indicator 18 in the form of a turn signal and at least one second direction-of-travel indicator 20, likewise in the form of a turn signal. In this case, at least one first direction-of-travel indicator 18 on a vehicle is in this case arranged on the left-hand side in a usual direction of travel of the vehicle and is designed to indicate a change of direction to the left. By contrast, the at least one second direction-of-travel indicator 20 on each vehicle is arranged on the right-hand side in the direction of a usual direction of travel of each vehicle and is designed to indicate a change of direction to the right. For the purpose of operating and hence also for the purpose of activating the direction-of-travel indicators 18, 20, each vehicle comprises a functional element that is usually in the form of a switch.

Furthermore, each vehicle comprises a computation unit 22, a communication module 24 as part of a radio-based or wireless communication network and a surroundings recognition system 26. Provision is made for each vehicle i.e., the first-party vehicle 12 and the two third-party vehicles 14, 16 that are shown here, to use the computation unit 22, for example, to register a current value of at least one kinematic variable for the vehicle while said vehicle is traveling and to use the communication module 24 and hence to use the communication network to provide said value for other vehicles. The at least one kinematic variable for describing the motion of the vehicle may be in the form of a location or position, speed and/or acceleration.

The surroundings recognition system 26 of a vehicle allows this vehicle to register other vehicles by means of electromagnetic waves and/or ultrasound by sensing. In this case, each surroundings recognition system 26 comprises at least one sensor that is usually arranged in and/or on an outer wall of the vehicle for the purpose of registering the surroundings.

In the case of the traffic situation presented here, a driver of the first-party vehicle 12 which is to overtake the first third-party vehicle 14. This requires a lane change from the second lane 6 to the first lane 4, which is announced by activation of the at least one first direction-of-travel indicator 18 on the first-party vehicle 12. As soon as the intended change has been announced, the computation unit 22 calculates a trajectory for the first-party vehicle 12. IN addition, information about the at least one kinematic variable of at least one third-party vehicle 14, 16 that is situated on the road is evaluated and an envisaged trajectory for this at least one third-party vehicle 14, 16 is calculated, and also a check is performed to determine whether the trajectory of the first-party vehicle 12 that is conditional upon the intended change coincides with the envisaged and/or calculated trajectory of the at least one third-party vehicle 14, 16 at a future instant. In this case, a value that is required in this regard for the at least one kinematic variable of the at least one third-party vehicle 14, 16 can be provided for the computation unit 22 via the communication network, which comprises the communication module 24 and/or the surroundings recognition system 26.

In the embodiment illustrated by means of FIG. 1, the trajectory of the first-party vehicle 12 is determined by calculating how long the first-party vehicle 12 will be situated in the first lane 4 for this purpose, and what route of what length the first-party vehicle 12 will cover in the process. Furthermore, besides the trajectory of the first third-party vehicle 14, the trajectory of the second third-party vehicle 16 needs to be calculated with priority in this case, the computation unit 22 ascertaining whether the trajectories for the planned lane change and/or overtaking process of the first-party vehicle 12 would coincide at a future instant, which would mean that the first-party vehicle 12 and the second third-party vehicle 16 would collide with one another, this being able to be prevented in one implementation of the presented method by providing an appropriate warning for the driver of the first-party vehicle 12.

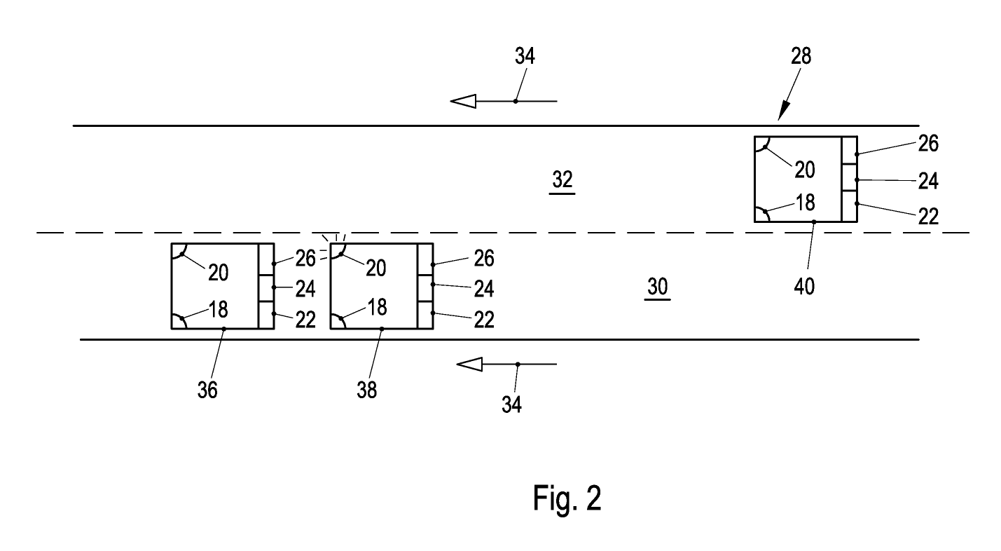

The second traffic situation, schematically presented by means of FIG. 2, takes place on a second road 28 with left-hand traffic that has a first lane 30 and a second lane 32, arranged parallel next to one another. In this case, vehicles are traveling in both lanes 30, 32 in the same direction 34. Traveling in the first lane 30 is a first vehicle in the form of third-party vehicle 36, behind which a vehicle in the form of a first-party vehicle 38 is traveling. These two vehicles are followed by a second third-party vehicle 40 in the second lane 32.

As already described with reference to the vehicles presented in FIG. 1, in this case too each of the presented vehicles has at least one first direction-of-travel indicator 18 in the form of a turn signal on a left-hand vehicle side and at least one direction-of-travel indicator 20, likewise in the form of a turn signal, on a right-hand vehicle side. Furthermore, each of the vehicles shown here has a computation unit 22, a communication module 24, as a component of a communication network that comprises all the communication modules 24, and a surroundings recognition system 26.

In this case, a driver of the first-party vehicle 38 plans to overtake the third-party vehicle 36 that is ahead of his first-party vehicle 38, this requiring a lane change from the first lane 30 to the second lane 32. The planned lane change for the first-party vehicle 38 is in this case announced by activation of the at least one direction-of-travel indicator 20 on the right-hand side. On the basis of this announcement of the intended change, a trajectory for the first-party vehicle 38 that is conditional upon this intended change to the further lane 32 is calculated by the computation unit 22 of said first-party vehicle. Furthermore, information about at least one kinematic variable for at least one further third-party vehicle 36, 40 that is situated on the road 28 is evaluated and an envisaged trajectory for this at least one third-party vehicle 36, 40 is calculated and a check is performed to determine whether the trajectory of the first-party vehicle 38 that is conditional upon the intended change coincides with the envisaged calculated trajectory of the at least one third-party vehicle 36, 40 at a shared instant.

In the case of the present embodiment, this requires it to be taken into account how long the first-party vehicle 38 will be situated in the second lane 32 while performing the planned overtaking process and what route is covered during this. Hence, a future and/or plannable value for at least one kinematic variable of the first-party vehicle is taken as a basis for calculating the planned trajectory of said first-party vehicle in the second lane 32.

The information about a value for at least one kinematic variable for the two third-party vehicles 36, 40, with the second third-party vehicle 40 that is behind in the second lane 32 needing to be considered with priority, can be taken as a basis for ascertaining whether there is the risk of the first-party vehicle 38 colliding with one of the third-party vehicles 36, 40 in the case of a possible coincidence of the trajectory of the first-party vehicle 38 with a trajectory of at least one of the third-party vehicles 36, 40 should the trajectories of said vehicles coincide at a shared instant. This can be avoided when the method is implemented, however, since, should the trajectories coincide at an instant, the driver of the first-party vehicle 38 is warned of the planned lane change before said lane change is implemented.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for operating a first-party vehicle that is traveling in a current lane along a road that is divided into a plurality of lanes, the method comprising:
announcing an intended change for the first-party vehicle from the current lane to a further, adjacent lane on the road by activation of a direction-of-travel indicator on the first-party vehicle,
calculating, in response to the announcement of the intended change to the further lane, a trajectory for the first-party vehicle that is conditional upon the intended change to the further lane.
evaluating information about at least one kinematic variable for at least one third-party vehicle that is situated on the road so as to calculate an envisaged trajectory for the at least one third-party vehicle, and
performing a check so as to determine whether the trajectory of the first-party vehicle that is conditional upon the intended change coincides with the envisaged trajectory of the at least one third-party vehicle at a future instant.

2. The method as recited in claim 1, wherein the activatable direction-of-travel indicator includes a turn signal.

3. The method as recited in claim 1, wherein the information about the at least one kinematic variable of the at least one third-party vehicle that is situated on the road is provided by at least one third-party vehicle that is situated on the road via a radio-based communication network.

4. The method as recited in claim 3, wherein the radio-based communication network is in the form of a public network, wherein the at least one third-party vehicle uses the radio-based communication network to provide information about the at least one kinematic variable of the at least one third-party vehicle.

5. The method as recited in claim 1, wherein the information about the at least one kinematic variable of the at least one third-party vehicle is ascertained by a surroundings recognition system of the first-party vehicle.

6. The method as recited in claim 1, wherein the intended change to the further lane is provided with a warning if the envisaged trajectory of the first-party vehicle coincides with the envisaged trajectory of the at least one third-party vehicle at the instant of the intended change to the further lane.

7. The method as recited in claim 1, which is performed for an intended change for the first-party vehicle from the current lane to a further, adjacent lane on the road, on which the traffic is flowing in the same direction by definition or in opposition directions by definition.

8. The method as recited in claim 1, further comprising ascertaining an envisaged trajectory by at least one third-party vehicle that is at least one of oncoming, ahead or behind on the road.

9. The method as recited in claim 1, further comprising ascertaining an envisaged trajectory by at least one third-party vehicle traveling in at least one of the current lane or the further, adjacent lane.

10. A system for operating a first-party vehicle that is traveling in a current lane along a road that is divided into a plurality of lanes, the system comprising:
at least one direction-of-travel indicator configured to announce an intended change for the first-party vehicle from the current lane to a further, adjacent lane on the road,
a computation unit configured to calculate, when the intended change to the further lane is announced, a trajectory for the first-party vehicle that is conditional upon the intended change to the further lane,
at least one information device configured to provide the computation unit with information about at least one kinematic variable for at least one third-party vehicle that is situated on the road,
wherein the computation unit is further configured to calculate an envisaged trajectory for the at least one third-party vehicle by evaluating the information provided and to check whether the trajectory of the first-party vehicle that is conditional upon the intended change coincides with the envisaged trajectory of the at least one third-party vehicle at an instant.

11. The system as recited in claim 10, wherein the at least one information device includes a communication module in a radio-based communication network that is designed to provide the computation unit with information about the at least one kinematic variable of the at least one third-party vehicle that is situated on the road.

12. The system as recited in claim 10, wherein the at least one information device includes a surroundings recognition system for the first-party vehicle that is configured to provide information about the at least one kinematic variable of the at least one third-party vehicle for the computation unit.

13. The system as recited in claim 12, wherein the surroundings recognition system includes at least one of a radar sensor, lidar sensor, laser sensor, video sensor or ultrasound sensor.
